(19) United States
(12) Patent Application Publication
(10) Pub. No.: US 2018/0047989 A1
(43) Pub. Date: Feb. 15, 2018

(54) SOLID COMPOSITION OF CARBON NANOFILLERS FOR FORMULATIONS USED IN LEAD BATTERIES

(71) Applicant: Arkema France, Colombes (FR)

(72) Inventors: Alexander KORZHENKO, Pau (FR); Christophe VINCENDEAU, Lons (FR); Patrick DELPRAT, Lescar (FR)

(21) Appl. No.: 15/554,453

(22) PCT Filed: Mar. 4, 2016
(86) PCT No.: PCT/FR2016/050502

§ 371 Date: Aug. 30, 2017

(30) Foreign Application Priority Data
Mar. 5, 2015 (FR) 1551843

(51) Int. Cl. H01M 4/62; H01M 10/06

(52) U.S. Cl. CPC H01M 4/625; H01M 10/06

(57) ABSTRACT

The invention relates to the field of lead batteries. More particularly, it relates to a solid composition comprising between 5 and 60 wt. % of carbon nanofillers, preferably carbon nanotubes, dispersed homogeneously in a hydrosoluble polymer in the presence of at least one cationic component selected from alkali or alkaline-earth metal cations and ammonium ions. The invention also relates to the use of said composition for producing lead battery electrode formulations.

### TECHNICAL FIELD

The present invention relates to the field of lead batteries. More particularly, the present invention relates to a solid composition comprising carbon-based nanofillers dispersed in a water-soluble polymer in the presence of at least one cationic component chosen from alkali metal or alkaline earth metal cations and ammonium ions, and to the use of this solid composition in the preparation of formulations for a lead battery electrode.

### STATE OF THE ART

Today, lead batteries are the most well-developed rechargeable electrochemical systems due to their high reliability and their low cost, in comparison with systems which are more recent in development, such as lithium ion batteries. Lead batteries are mainly used to supply the electrical ignition of internal combustion engines, in particular of vehicles, as they are capable of providing a current of high intensity, but they can also be used to store energy intermittently, such as solar or wind energy.

A lead battery is a set of lead/acid elements (or cells) connected in series and combined in one and the same casing. The battery provides electrical energy only if it has been charged beforehand. The elements are in a position to accumulate and to restore the electrical energy by reversible electrochemical reactions occurring during the charging/discharging cycles of the battery.

The performance of a lead battery is essentially evaluated by the maximum current which it can provide in a few moments, by its storage capacity for the available energy and by the number of charging/discharging cycles before complete discharge, which is reflected by a lifetime of the battery.

Typically, in a lead battery, each cell comprises an assembly of electrodes (an anode and a cathode), which are connected with an electrolyte of sulfuric acid type, and the cells are separated from one another by a membrane which can be made of polypropylene, for example.

The anode consists mainly of lead oxide and the cathode of finely distributed spongy lead, and they are produced with a current collector generally made of lead or of a lead alloy, such as Pb/Sb or Pb/Ca.

The sulfuric acid, in the dilute aqueous solution or gel form, supplies a stream of sulfate ions between the electrodes. The discharging/charging cycles of the battery are thus reflected by a process of sulfation of the electrodes during the discharging, which is reversible during the charging. However, under certain conditions, the sulfation can generate a stable deposit of lead sulfate on the electrodes, which prevents the electrochemical reactions, in particular the oxidation of the lead during the charging, and thus optimal use of the active material of the electrodes.

The effectiveness of the transfer of the sulfate charges between the electrodes and the electrolyte is mainly responsible for the performance and the longevity of the battery.

Various routes have already been explored in the prior art for improving the performance levels of lead batteries, in particular the addition of carbon-based nanofillers, such as carbon nanotubes, to the active material formulations of the electrodes.

This is because carbon nanotubes (CNTs), consisting of wound graphite sheets, are known for their excellent electrical conductivity and are stable in acidic or corrosive environments. However, CNTs prove to be difficult to handle and to disperse, due to their small size, to their pulverulence and possibly, when they are obtained by chemical vapor deposition (CVD), to their entangled structure furthermore generating strong Van Der

Waals interactions between their molecules. The weak dispersion of the CNTs in the matrices in which they are incorporated, in particular aqueous electrode formulations, limits their effectiveness and can even affect the transfers of charge between the electrode and the electrolyte and thus the performance of the battery. In order to overcome the disadvantages related to the incorporation of CNTs in lead battery electrode formulations, the proposal has been made to employ CNTs functionalized by oxygen-comprising groups or by conducting polymers, such as polythiophene, for the purpose of improving their compatibility with the electrode formulation. However, this method, described in the document WO 2013/011516, results in an additional cost related to the nature of the nanofillers added.

The document WO 2014/114969 provides a dry route for the incorporation of carbon-based nanofillers, in particular crude CNTs, in a pasty electrode formulation which consists in preparing an intimate mixture of CNTs and lead oxide in the powder form using various grinding technologies, for example with a ball mill. This mixture, comprising from 5% to 20% by weight of CNTs in lead oxide, can be used directly in the preparation of an electrode formulation or it can be mixed with lead oxide in order to dope the latter with carbon-based nanofillers. However, this approach is difficult to operate industrially, in view of the large amounts of powder to be coground.

The document WO 2012/177869 describes compositions comprising carbon nanotubes intended for improving the performance levels of lead batteries. The carbon nanotubes are oxidized beforehand and are formulated in an expander in order to prepare electrode active materials.

It has also been suggested, in the document WO 2014/141279, to spray a suspension of CNTs in the form of droplets of predetermined size over a matrix comprising lead oxide, in order to homogeneously incorporate CNTs in an electrode formulation. The suspension, with a concentration which can range from 0.005% to approximately 0.1% by weight, is prepared by addition of the CNTs to an aqueous medium under mechanical stirring or under ultrasonic agitation. However, it proves difficult to accurately meter the crude CNTs, which are in the pulverulent state, at this low concentration level.

There thus still remains a need to have available a simple, reliable and economical means for homogeneously incorporating carbon nanotubes in electrode formulations for a lead battery.

In point of fact, the applicant company has discovered that this need could be met by making available a solid composition comprising carbon nanotubes dispersed in a water-soluble polymer.

The document WO 2011/0117530 describes a masterbatch in the agglomerated solid form based on CNTs, on a polymer binder, which can be a modified cellulose, and optionally on a solvent, which can be used for the preparation of liquid formulations containing CNTs, but its use for preparing electrode formulations for a lead battery has not been envisaged in the slightest.

Furthermore, it is apparent to the applicant company that the combination of a water-soluble polymer with a cationic component makes it possible to render CNTs, which are intrinsically hydrophobic, more readily compatible with aqueous systems.

The invention thus provides a solid composition comprising carbon nanotubes dispersed in a water-soluble polymer in the presence of at least one cationic component chosen from alkali metal or alkaline earth metal cations and ammonium ions. This composition is thus ready for use in order to be used easily and in complete safety for preparing formulations for the manufacture of electrodes for the purpose of increasing their electrical conductivity and improving the overall performance levels of lead batteries.

Furthermore, this invention can also be applied to other carbon-based nanofillers than carbon nanotubes and in particular to graphene or a mixture of carbon nanotubes and graphene in all proportions.

### SUMMARY OF THE INVENTION

A subject matter of the present invention is a solid composition comprising from 5% to 60% by weight of carbon-based nanofillers homogeneously dispersed in at least one water-soluble polymer in the presence of from 0.05% to 50% by weight of at least one cationic component chosen from alkali metal or alkaline earth metal cations and ammonium ions.

The composition according to the invention comprises carbon-based nanofillers chosen from carbon nanotubes (CNTs), graphene or a mixture of CNTs and graphene in all proportions.

According to the invention, the water-soluble polymer is chosen from polysaccharides; modified polysaccharides, such as modified celluloses; polyethers, such as polyalkylene oxides or polyalkylene glycols; lignosulfonates; polyacrylates; products based on polycarboxylic acids, in particular polyether polycarboxylates or their copolymers; naphthalenesulfonates and their derivatives; and their corresponding aqueous solutions.

The present invention provides a composition concentrated in carbon-based nanofillers which makes it possible to obtain stabilized dispersions during the preparation of electrode formulations and to create a better combination of the particles of carbon-based nanofillers with the different active constituents of the formulation, in particular with lead or lead oxide. In addition, the composition according to the invention contributes to limiting the phenomena of corrosion and of cracking of the electrodes which limit the lifetime of the battery.

Thus, another subject matter of the invention is the use of said composition in the preparation of a lead battery electrode formulation.

Another aspect of the invention relates to a lead battery electrode capable of being obtained or obtained from said composition, it being possible for this electrode to be an anode or a cathode, and also to the lead battery comprising at least said electrode.

### DETAILED DESCRIPTION OF THE INVENTION

The invention is now described in greater detail and in a nonlimiting manner in the description which follows.

### The Carbon-Based Nanofillers

“Carbon-based nanofiller” denotes a carbon-based filler, the smallest dimension of which is between 0.1 and 200 nm, preferably between 0.1 and 160 nm and more preferably between 0.1 and 50 nm, measured by light scattering.

In the continuation of this description, “carbon-based nanofillers” are carbon nanotubes (CNTs), graphene or a mixture of CNTs and graphene in all proportions.

Preferably, the carbon-based nanofillers are carbon nanotubes. CNTs have specific crystalline structures, of tubular shape and hollow, obtained from carbon. CNTs generally consist of one or more graphite sheets arranged concentrically around a longitudinal axis. A distinction is thus made between single-walled nanotubes (SWNTs) and multi-walled nanotubes (MWNTs).

Carbon nanotubes usually have a mean diameter ranging from 0.1 to 200 nm, preferably from 0.1 to 100 nm, more preferably from 0.4 to 50 nm and better still from 1 to 30 nm, indeed even from 10 to 15 nm, and advantageously have a length of more than 0.1 μm and advantageously from 0.1 to 20 μm, preferably from 0.1 to 10 μm, for example of approximately 6 μm. Their length/diameter ratio is advantageously greater than 10 and generally greater than 100. Their specific surface is, for example, between 100 and 300 m²/g, advantageously between 200 and 300 m²/g, and their bulk density can in particular be between 0.01 and 0.5 g/cm³ and more preferably between 0.07 and 0.2 g/cm³. Multi-walled carbon nanotubes can, for example, comprise from 5 to 15 sheets and more preferably from 7 to 10 sheets.

CNTs can be produced according to different processes; however, the CNTs participating in the composition according to the invention are preferably synthesized by chemical vapor deposition (CVD) as this process is the most suitable for industrial manufacture in terms of quality of the CNTs.

An example of such crude carbon nanotubes is in particular the trade name Graphistrength® C100 from Arkema.

These nanotubes can be purified and/or treated (for example oxidized) and/or ground.

The grinding of the nanotubes can in particular be carried out under cold conditions or under hot conditions and can be carried out according to the known techniques employed in devices such as ball, hammer, edge runner, knife or gas jet mills or any other grinding system capable of reducing the size of the entangled network of nanotubes. It is preferable for this grinding stage to be carried out according to a gas jet grinding technique and in particular in an air jet mill.

The crude or ground nanotubes can be purified by washing using a sulfuric acid solution, so as to free them from possible residual inorganic and metallic impurities, such as, for example, iron, originating from their preparation process. The ratio by weight of the nanotubes to the sulfuric acid can in particular be between 1:2 and 1:3. The purification operation can furthermore be carried out at a temperature ranging from 90° C. to 120° C., for example for a period of time of 5 to 10 hours. This operation can advantageously be followed by stages in which the purified nanotubes are rinsed with water and dried. In an alternative form, the nanotubes can be purified by high-temperature heat treatment, typically at greater than 1000° C.

The oxidation of the nanotubes is advantageously carried out by bringing the latter into contact with a sodium hypochlorite solution including from 0.5% to 15% by weight of NaOCl and preferably from 1% to 10% by weight of NaOCl, for example in a ratio by weight of the nanotubes to the sodium hypochlorite ranging from 1:0.1 to 1:1. The oxidation is advantageously carried out at a temperature of less than 60° C. and preferably at ambient temperature, for a period of time ranging from a few minutes to 24 hours. This oxidation operation can advantageously be followed by stages in which the oxidized nanotubes are filtered and/or centrifuged, washed and dried.

Use is preferably made, in the present invention, of crude carbon nanotubes, that is to say nanotubes which are neither oxidized nor purified nor functionalized and which have not been subjected to any other chemical and/or heat and/or mechanical treatment.

Furthermore, it is preferable to use carbon nanotubes obtained from renewable starting material, in particular of vegetable origin, as described in the application FR 2 914 634.

The graphene which can participate in the composition according to the invention is obtained by chemical vapor deposition or CVD, preferably according to a process using a pulverulent catalyst based on a mixed oxide. It is characteristically provided in the form of particles having a thickness of less than 50 nm, preferably of less than 15 nm and more preferably of less than 5 nm, and having lateral dimensions of less than a micron, preferably from 10 nm to less than 1000 nm, more preferably from 50 to 600 nm, indeed even from 100 to 400 nm. Each of these particles generally includes from 1 to 50 sheets, preferably from 1 to 20 sheets and more preferably from 1 to 10 sheets, indeed even from 1 to 5 sheets, which are capable of being separated from one another in the form of independent sheets, for example during a treatment with ultrasound.

The Water-Soluble Polymer

The water-soluble polymer can be ionic or nonionic.

Use is made, in the present invention, as water-soluble polymers, of polysaccharides; modified polysaccharides, such as modified celluloses; polyethers, such as polyalkylene oxides or polyalkylene glycols; lignosulfonates; polyacrylates; products based on polycarboxylic acids, in particular polyether polycarboxylates or their copolymers; naphthalenesulfonates and their derivatives; and their corresponding aqueous solutions.

Preferably, the water-soluble polymer is chosen from modified celluloses, in particular carboxymethylcellulose (CMC), lignosulfonates, polyether polycarboxylates or their copolymers, naphthalenesulfonates and their derivatives, and their corresponding aqueous solutions.

Use may be made of several water-soluble polymers in the form of a mixture in all proportions.

Use may be made, for example, of the commercial products of the Ethacryl range or the product XP 1824 from Coatex.

The water-soluble polymers are generally commercially available in the solid form or in the form of an aqueous solution having a more or less high viscosity.

The Cationic Components

The presence of a cationic component, in particular of at least one cation of an alkali metal or alkaline earth metal or of ammonium ion, in the composition according to the invention contributes to ensuring the stabilization of the dispersion of the carbon-based nanofillers. In addition, it makes it possible to limit the problems of corrosion in the electrode formulation.

Alkali metal or alkaline earth metal cations are preferred as cationic component. Mention may be made, as cations, for example, of Na⁺, K⁺, Mg²⁺, Ca²⁺ or Ba²⁺, used alone or as a mixture; preferably, the cations are Na⁺.

The cationic components are present in the composition according to the invention, generally by introduction of a base in aqueous solution, or they can be contributed, at least in part, by the water-soluble polymer when the latter is in a salified form.

The Solid Composition

The solid composition according to the invention is a composition which is stable over time (no change in physical appearance or in coloring), which can be prepared independently of the plant for production of the lead battery electrodes and thus which can be stored or transported for a subsequent use. It comprises from 5% to 60% by weight of carbon-based nanofillers, with respect to the total weight of the composition, homogeneously dispersed throughout the body of the composition, and it is ready for use.

According to one embodiment of the invention, the solid composition comprises from 18% to 50% by weight, preferably from 40% to 50% by weight, of carbon-based nanofillers, with respect to the total weight of the composition.

The solid composition comprises from 0.05% to 50% by weight of cationic component, preferably from 0.05% to 10% by weight, more preferably from 0.05% to 5% by weight, indeed even from 0.1% to 3% by weight, of cationic component, with respect to the total weight of the composition.

According to one embodiment of the invention, the water-soluble polymer represents from 20% to 80% by weight, preferably from 20% to 60% by weight, with respect to the total weight of the composition.

The composition according to the invention is in a solid form, generally in an agglomerated physical form, such as granules.

The composition according to the invention can additionally comprise water, up to approximately 90% by weight, and remain in a solid form. It is then provided in a wet solid form generally comprising from 10% to 30% by weight, preferably from 18% to 25% by weight, of CNTs. The wet composition can then be dried in order to result in a concentrated composition preferably comprising from 40% to 50% by weight of CNTs in an agglomerated physical form.

The composition according to the invention is advantageously prepared using a compounding device.

“Compounding device” is understood to mean an appliance conventionally used in the plastics industry for the melt blending of thermoplastic polymers and additives for the purpose of producing composites.

In this appliance, the water-soluble polymer and the carbon-based nanofillers in the presence of cations are mixed using a high-shear device, for example a corotating twin-screw extruder or a co-kneader.

Examples of co-kneaders which can be used are the Buss® MDK 46 co-kneaders and those of the Buss® MKS or MX series, sold by Buss AG, which all consist of a screw shaft provided with flights which is positioned in a heating barrel optionally consisting of several parts, the internal wall of which is provided with kneading teeth appropriate for interacting with the flights to produce shearing of the kneaded material. The shaft is driven in rotation and provided with an oscillating movement in the axial direction by a motor. These co-kneaders can be equipped with a system for manufacturing granules, for example attached to their outlet orifice, which can consist of an extrusion screw or of a pump.

The co-kneaders which can be used preferably have a screw ratio L/D ranging from 7 to 22, for example from 10 to 20, while the corotating extruders advantageously have an L/D ratio ranging from 15 to 56, for example from 20 to 50.

According to one embodiment, the nanofillers in the solid state and the solid water-soluble polymer are introduced simultaneously into the same feed zone of the device, and an aqueous solution of a base is introduced into a separate feed zone.

According to one embodiment, the nanofillers in the solid state are introduced into a first feed zone of the device and the water-soluble polymer in aqueous solution, salified or additivated with a base, is introduced into a separate feed zone.

The kneading of the different constituents can be carried out at a temperature of preferably between 20° C. and 90° C.

The dispersion of the nanofillers thus produced in the presence of the cations is effective and homogeneous during the compounding. The cations subsequently promote the incorporation of these nanofillers in formulations in an acidic aqueous medium, such as electrode formulations for a lead battery.

By way of comparison, it was not possible to obtain a composition comprising 20% of carbon nanotubes in a polyethylene oxide in the absence of Na⁺ cations in this type of appliance.

The molten material generally exits from the appliance in an agglomerated solid physical form, for example in the form of granules, or in the form of rods which, after cooling, are cut up into granules.

The composition thus obtained can subsequently optionally be dried by any known process (ventilated or vacuum oven, infrared, induction, microwaves, and the like) with the aim in particular of removing all or part of the water present and of thus obtaining a composition more concentrated in carbon-based nanofillers.

The composition according to the invention can optionally be subjected to a grinding stage according to techniques well known to a person skilled in the art, so as to obtain a composition in the powder form.

Use of the Composition

Another aspect of the invention relates to the use of a solid composition comprising from 5% to 60% by weight of carbon-based nanofillers homogeneously dispersed in at least one water-soluble polymer in the presence of at least one cationic component chosen from alkali metal or alkaline earth metal cations and ammonium ions, in the preparation of a lead battery electrode formulation.

In this aspect, the composition according to the invention is used to homogeneously incorporate carbon-based nanofillers in a pasty composition intended to cover a solid current collector in order to form an electrode. The incorporation of the carbon-based nanofillers is facilitated as a result of their combination with a water-soluble polymer and cations, thus giving them a hydrophilic nature compatible with the aqueous formulations of the electrodes.

The incorporation of the carbon-based nanofillers in the electrode formulation can be carried out directly from the solid composition according to the invention or via an aqueous dispersion prepared from the solid composition according to the invention.

The electrode can be an anode or a cathode.

The electrode formulation, generally in the form of a pasty composition, can comprise lead oxide, water, sulfuric acid, mechanical reinforcing fillers, such as glass fibers, carbon fibers or polyester fibers, and various compounds, including barium sulfate or carbon black, or other electroactive compounds.

Lead oxide is understood to mean a mixture of lead oxides of formula PbOₓ with 1≦x≦2, with the possible presence of nonoxidized lead.

The mixing of the constituents of the formulation in order to form the paste can be carried out in any type of mixing device, such as a blade mixer, a planetary mixer, a screw mixer, and the like.

The proportions of the various compounds used in the electrode formulation are adjusted so that the amount of carbon-based nanofillers advantageously varies from 0.0005% to 1% by weight, with respect to the weight of the formulation, preferably from 0.001% to 0.5% by weight and preferably from 0.001% to 0.01% by weight, with respect to the weight of the formulation.

The sulfuric acid can be present at a concentration ranging from 1 to 20 mol/l and preferably between 3 and 5 mol/l. The sulfuric acid can represent from 1% to 10%, preferably from 2% to 7%, of the total weight of the formulation.

The amount of water present in the pasty composition is between 7% and 20% by weight, with respect to the weight of the pasty composition.

The mechanical reinforcing fillers, preferably glass fibers, are present at a content ranging from 0.1% to 1% by weight, with respect to the weight of the pasty composition.

The invention also relates to a lead battery electrode, such as an anode or a cathode, capable of being obtained or obtained from a solid composition as described above.

A process for the preparation of an electrode for a lead battery can comprise, for example, at least the following stages:
a) making available a solid composition as described above;
b) preparing a pasty composition comprising the use of the solid composition of stage a);
c) impregnating a grid using the pasty composition of stage b);
d) pressing, followed by drying and maturing the impregnated grid.

It is clearly understood that the above process can comprise other preliminary, intermediate or subsequent stages, provided that they do not have a negative effect on the obtaining of the desired electrode.

The grid can be flexible or rigid or be provided in different forms. The grid is composed of lead or of a lead-based alloy.

After the application of the paste to the grid, drying is generally carried out at a temperature ranging from 30° C. to 65° C., under at least 80% relative humidity, for more than 18 hours. Maturing is then preferably carried out, for example from 55° C. to 80° C. under an ambient relative humidity, for one to three days.

Another subject matter of the invention is a lead battery comprising at least one electrode, which can be an anode or a cathode, according to the invention.

A lead battery generally comprises a separator between each pair of positive and negative electrodes. This separator can be any porous nonconducting material, for example a sheet of polypropylene or of polyethylene. Its thickness can vary from 0.01 to 0.1 mm. A pair of electrodes and a separator define a cell. The lead battery of the present invention can comprise from 1 to 12 cells, which can provide a voltage at each of 1.5 to 2.5 volts.

The incorporation of the carbon-based nanofillers using the composition of the invention makes it possible to significantly improve the number of charging/discharging cycles of the battery and to limit the problems of cracking of the electrodes, and it thus prolongs the operational lifetime of the battery.

The invention will now be illustrated by the following examples, which do not have the aim of limiting the scope of the invention, defined by the appended claims.

### Experimental Part

### EXAMPLE 1

### Preparation of a solid CNT/CMC composition

The CNTs (Graphistrength® C100 from Arkema) were introduced into the first feed hopper of a Buss® MDK 46 (L/D=11) co-kneader with the CarboxyMethylCellulose (CMC) of low weight (Finnfix® 2 grade) in the solid form.

A 1% solution of NaOH in demineralized water was injected at 30° C. into the 1st zone of the co-kneader.

The set temperature values and the throughput within the co-kneader are as follows: Zone 1: 30° C., Zone 2: 30° C., Screw: 30° C., Throughput: 15 kg/h.

At the outlet of the die, the granules of the composition were cut up under dry conditions.

A solid composition was obtained in the form of granules which can be dried in an oven at 80° C. for 6 hours in order to remove the water.

The final solid composition in the form of granules contains 45% by weight of carbon nanotubes, 53% by weight of CMC and 2% by weight of Na⁺.

The dried granules are packaged in an airtight container in order to prevent uptake of water during storage or transportation until the composition is used to prepare a lead battery electrode formulation.

### Example 2

### Preparation of a Solid Composition Comprising 20% of CNTs

The CNTs (Graphistrength® C100 from Arkema) were introduced into the first feed hopper of a Buss® MDK 46 (L/D=11) co-kneader.

A polyether polycarboxylate (PEC) in aqueous solution (Ethacryl® HF grade from Coatex) was premixed with 40% of a solution of the soluble fraction of lignosulfonate (LS) neutralized with 2% by weight of NaOH.

This premix is composed, by weight, of 20% of PEC, 20% of LS and 1% of NaOH.

This liquid mixture was injected at 30° C. into the 1st zone of the co-kneader. The set temperature values and the throughput of the co-kneader are as follows:

Zone 1: 30° C., Zone 2: 30° C., Screw: 30° C., Throughput: 15 kg/h.

At the outlet of the die, the granules of the composition were cut up under dry conditions. The final composition, in the form of a wet solid, comprises 20% by weight of carbon nanotubes, 16% of PEC, 16% of LS and approximately 1% of Na⁺. It is used to prepare a lead battery electrode formulation.

The granules were packaged in an airtight container in order to prevent loss of water during storage.

1-10. (canceled)

11. A solid composition comprising
from 5% to 60% by weight of carbon-based nanofillers, wherein the carbon-based nanofillers comprise carbon nanotubes, graphene or a mixture of CNTs and graphene in all proportions;
at least one water-soluble polymer, wherein the water-soluble polymer comprises polysaccharides, modified polysaccharides, polyethers, lignosulfonates, polyacrylates, products based on polycarboxylic acids, naphthalenesulfonates and their derivatives; and their corresponding aqueous solutions; and
from 0.05% to 50% by weight of at least one cationic component, wherein the at least one cationic component comprises alkali metal or alkaline earth metal cations and ammonium ions, and
wherein the carbon-based nanofillers are homogeneously dispersed in the at least one water-soluble polymer in the presence of the at least one cationic component.

12. The composition of claim 11, wherein the composition is in an agglomerated physical form and wherein the composition comprises from 18% to 50% by weight of the carbon-based nanofillers, with respect to the total weight of the composition.

13. The composition of claim 11, further comprising water, wherein the composition is in a wet solid form comprising from 10% to 30% by weight of the carbon-based nanofillers, with respect to the total weight of the composition.

14. The composition of claim 11, wherein the carbon-based nanofillers comprise crude carbon nanotubes that have not been subjected to any chemical, thermal and/or mechanical treatment.

15. The composition of claim 11, wherein the water-soluble polymer is selected from the group consisting of modified celluloses, lignosulfonates, polyether polycarboxylates or their copolymers, naphthalenesulfonates and their derivatives, and their corresponding aqueous solutions.

16. The composition of claim 11, wherein the composition comprises from 0.05% to 10% by weight of the cationic component, with respect to the total weight of the composition.

17. The composition of claim 11, wherein the cationic component is a Na⁺ cation.

18. A lead battery electrode obtained from the composition of claim 11.

19. A lead battery comprising the at least one electrode of claim 18.

20. The electrode of claim 18, wherein the electrode is an anode.

21. The electrode of claim 18, wherein the electrode is a cathode.
